(19) United States
(12) Patent Application Publication
(10) Pub. No.: US 2016/0325464 A1
(43) Pub. Date: Nov. 10, 2016

(54) THREE DIMENSIONAL CARBON ARTICLES

(71) Applicant: GrafTech International Holdings Inc., Brooklyn Heights, OH (US)

(72) Inventors: Tracy L. Albers, Westlake, OH (US); Gregory Sowa, Orrville, OH (US); Saad Hasan, Chicago, IL (US); Kasi David, Lakewood, OH (US); Xuliang Dai, Solon, OH (US); Ryan M. Paul, Parma, OH (US)

(21) Appl. No.: 15/066,535

(22) Filed: Mar. 10, 2016

Related U.S. Application Data
(63) Continuation-in-part of application No. PCT/US2014/050089, filed on Aug. 7, 2014.
(60) Provisional application No. 61/876,991, filed on Sep. 12, 2013.

(51) Int. Cl. B28B 1/00; B33Y 70/00; C04B 35/64; B33Y 10/00; C04B 35/532; C04B 35/628

(52) U.S. Cl. CPC B28B 1/001; C04B 35/532; C04B 35/62839; C04B 35/64; B33Y 10/00; B33Y 70/00

(57) ABSTRACT

A method for making a three dimensional carbon and graphite articles using three dimensional printing techniques is provided. The method includes depositing alternating layers of a binder and a filler to form an article. The filler includes at least one of carbon, graphite and combinations thereof. The article is heat treated in a non-oxidizing environment to at least about 2000° C. Another method of forming an article includes depositing alternating layers of a binder and a filler, wherein said filler includes a carbon or graphite powder in combination with a milled pitch. The binder volatizes at a temperature greater than a softening point temperature of the milled pitch, the article is heat treated in a non-oxidizing environment to at least about 800° C.

### CROSS REFERENCE TO RELATED APPLICATIONS

This application is a Continuation in Part of International Application No. PCT/US2014/050089, filed on Aug. 17, 2014, which in turn claims the benefit of Provisional Patent Application No. 61/876,991 filed Sep. 12, 2013, the disclosures of which are incorporated by reference herein.

### BACKGROUND

Additive manufacturing (otherwise referred to as 3D printing) is rapidly becoming mainstream as the technology improves and the costs go down. The process involves making three-dimensional solid objects for use in any number of applications. Traditionally, 3D printing techniques were first used for rapid prototyping. However, recently with the reduction in costs and advancements in equipment and related software, 3D printing may be used in distributed or discrete manufacturing applications, with uses in, for example, construction, automotive, aerospace, and biotech.

As the name suggests, additive manufacturing is an additive process, where successive layers of material are laid down to form articles based on a digital design. In this manner, 3D printing is distinct from traditional article machining approaches, which generally rely on the removal of material to form an article.

### BRIEF DESCRIPTION

According to one aspect, a method for making a three dimensional article includes depositing alternating layers of a binder and a filler to form an article. Fillers include carbon and/or graphite based powders. Thereafter, the article is heat treated in a non-oxidizing environment to at least about 2000° C.

According to another aspect, a method for making a three dimensional article includes forming an article by depositing alternating layers of a binder and a filler. The filler includes a carbon and/or graphite powder in combination with a milled pitch. The binder partially volatizes at a temperature greater than the softening point temperature of the milled pitch. The article is then heat treated in a non-oxidizing environment to at least about 800° C.

### DETAILED DESCRIPTION OF THE INVENTION

The concepts described herein relate to the formation of carbon and graphite articles using three dimensional printing techniques.

According to one embodiment, a three dimensional article may be formed employing a layered approach wherein alternating layers of binder, then filler (as described herein below, the filler may include an uncoated powder, coated powder or powder/pitch mixture), are deposited on a target surface. In accordance with this approach the binder should be flowable at processing temperatures but then set or become substantially solid shortly after deposition on the target surface (or on the previous filler layer). According to this method, optionally the binder may be set by employing a targeted heat source such as, for example, a laser. In other embodiments, the binder sets after deposition without an additional energy or heat source. In this manner, a three-dimensional article may be formed.

Exemplary binders may include coal tar pitch, petroleum pitch, or lignin based pitch. In other embodiments, the binder may be a resin, preferably having a coking value greater than at least 20 percent, still more preferably greater than at least 30 percent, and still more preferably greater than 40 percent. Exemplary resins may include phenolic resins, epoxy resins, polyimides or polyacrylonitrile (‘PAN”) base polymers.

The filler is a carbon based material and may include uncoated carbon or graphite powders. In another embodiment, the filler includes carbon or graphite powders having a coating applied thereon. In still further embodiments, the filler may include a mixture of a coated or uncoated powder with a milled pitch. In still further embodiments, the filler may include two or more coated or uncoated powders. In still further embodiments, the filler may include a two or more coated or uncoated powders and a milled pitch.

Exemplary uncoated powders may include calcined or uncalcined petroleum based coke powder, calcined or uncalcined pitch coke powders, calcined or uncalcined lignin based coke powder, graphitized coke powder, graphitized coal, or natural graphite. Exemplary coated powders may include a base powder including calcined or uncalcined petroleum coke, calcined or uncalcined pitch coke, calcined or uncalcined lignin based coke powder, graphitized coke, natural graphite or graphitized carbon material. The base powders are advantageously coated with a graphitizable material derived from, for example, coal tar pitch, petroleum pitch, or a resin (for example phenolic resin) at a loading level of from about 1 to about 75 percent by weight of the base powder. In other embodiments, the loading level is from between about 1 and about 50 percent by weight of the base powder. In one embodiment, after application of the coating, the coated powder is carbonized. In other embodiments, after application of the coating, the coated powder is graphitized. In still further embodiments, after application of the coating, the coated powder does not receive a heat treatment prior to use in the three dimensional article.

In one embodiment, the coated or uncoated powders have a generally spherical shape. In this embodiment, preferably the average aspect ratio is less than about 4, still more preferably less than about 3 and still more preferably less than about 2. In other embodiments, the coated or uncoated powders may be other shapes, for example, plate or needle shaped. In one embodiment, the particle sizing of the coated or uncoated powders may be from about 2 micron to about 200 microns in average diameter. In other embodiments, the average diameter is less than about 200 microns. In one or more embodiments, a bi-modal distribution of powder is employed to increase packing density.

While 3D printing of metal powders can be done with powders as fine as d50=25 micron, 3D printing graphite may require a different sized particle. It has been found that a d50=60 micron improves the flowability of the powder. Flowability is defined as, whether the powder particles pour past each other, rather than cling to each other. Sand-like flowability is good; flour-like flowability is less desirable. For graphite, the cutoff above which desirable sand-like flowability is achieved is with the use of about 200 mesh particles.

In some 3D printing embodiments, the upper cutoff particle size that the printer can handle is 150 microns. Therefore, an desired graphite powder for 3D printing may be defined as −100/+200 mesh.

In one embodiment, the powder mixture may include one or more of the above described coated or uncoated powders and a powdered pitch. The powdered pitch may be, for example, coal tar pitch or petroleum pitch. The pitch may be milled or otherwise processed to powder form. The average pitch powder diameter is preferably less than about 500 microns and still more preferably less than about 400 microns. Other examples of average pitch powder diameter include up to 350 microns, up to 300 microns, up to 250 microns, up to 200 microns and up to 150 microns. In other embodiments, the pitch powder is from between about 1 micron and about 100 microns. In one embodiment, the pitch particles are smaller than the coated or uncoated powder to ensure the shape and surface integrity of the final printed artifact. The pitch should be mixed with the coated and/or uncoated powder to a loading level of from between about 1 to about 75 percent by weight. In other embodiments, the pitch is mixed with the coated and/or uncoated powder to a loading level of from between about 10 and about 50 percent by weight. In one embodiment, the pitch material may have a softening point from between about 80° C. and about 300° C. In one embodiment, the pitch material has a softening point greater than about 80° C. In other embodiments, the pitch material has a softening point greater than about 120° C. In still further embodiments the pitch material has a softening point greater than about 150° C. Preferably the coking value of the pitch is greater than about 30%, more preferably at least about 50% and still more preferably at least about 60%.

A 3D article formed in accordance with the present disclosure, and prior to any further heat treatment is hereafter referred to as a green article. In one embodiment, the green article is heat treated in a non-oxidizing atmosphere to at least about 800° C., in other embodiments at least about 1000° C., still other embodiments at least about 1200° C. For purposes of the present disclosure, heat treatment above 800° C. is hereinafter referred to as carbonizing the article. In one embodiment, the carbonized article may thereafter be heat treated in a non-oxidizing atmosphere to at least about 2000° C., in other embodiments at least about 2500° C., and still other embodiments least about 3000° C. For purposes of the present disclosure, heat treatment above about 2000° C. is hereinafter referred to as graphitizing the article. In one embodiment, the step of carbonizing the article is separate from the step of graphitizing the article. In other words, the article is carbonized, allowed to cool, and thereafter graphitized. In other embodiments, the article is carbonized and graphitized in the same step, in other words, the article is heated to at least 800° C., and without a subsequent cooling step, the article is heated further to at least 2000° C.

In one or more embodiments, the article may receive a pitch impregnation treatment. Examples of impregnation pitch include petroleum pitch, coal tar pitch or other carbonaceous resin systems. The pitch impregnation step commonly is performed using an autoclave system. Pitch impregnation treatment may be performed before or after the article is carbonized. If performed after, advantageously the pitch impregnated article is again carbonized. Pitch impregnation generally increases strength and density while reducing porosity of the article.

According to one embodiment, a three dimensional article may be formed employing a layered approach as described above wherein successive layers of binder, and filler (wherein the filler is a powder mixture), are deposited on a target surface. In accordance with this embodiment, the binder preferably volatizes at temperatures greater than the melting point of the pitch in the powder mixture. In accordance with this embodiment, for example, the binder maybe be selected such that substantially all of the binder volatizes at temperatures above about 200 C and the pitch of the powder mixture has a melting point less than about 200 C. In other embodiments, the binder volatizes at temperatures above 300 C and the pitch of the powder mixture has a melting point less than about 300 C. In this manner, a three dimensional article may be formed wherein the binder sets the shape during three dimensional formation. During the later heat treatment step, the pitch in the powder mixture first softens, then carbonizes, which maintains the form and structural integrity of the article. Likewise, substantially all of the binder volatizes during the heat treatment so that the final heat treated article (either carbonized or graphitized) is substantially free of the original binder. Thus, the binder in accordance with this embodiment is a sacrificial binder which may be any material that provides adequate adhesive characteristics during formation, but then substantially or completely volatizes in later heat treatment steps. The advantage of this process is in the printing/forming of the three dimensional article, wherein the sacrificial binder can be liquid at room temperature (where pitches are in solid form), yet the final artifact would allow each carbon or graphite particle to connect to form a cohesive structure as the binder pitch particles are melted and re-crystallized during heat treatment to form the final artifact.

According to one embodiment, the final carbonized or graphitized article may have a density of from between about 1.0 g/cc to about 2.2 g/cc. In particular, density is increased by one or more pitch impregnation steps. In other embodiments, the carbon or graphite article may be generally porous, having a density from between about 0.10 g/cc to about 1.0 g/cc. Generally, porous relatively low density carbon or graphite articles do not receive a pitch impregnation step prior to or after heat treatment.

Other embodiments can use a 3D printer to manufacture porous graphite. Applications for a 3D-printed porous carbon or porous graphite object, such SiC crystal growing market with various graphite products including powders, furnace parts, and porous graphite. Currently, the porous graphite component is manufactured by first producing a billet, then cutting out the part you need. Given the typical dimensions (e.g., 10-inch diameter, 1-mm thickness) for the porous graphite part, 3D printing is an appropriate method to generate the part with tight control of the dimensions and minimal waste/use of excess material.

3D printing can control particle assembly, using a combination of powder and binder/resin. The 3D printer may offer better control of the pore structure, or even allow it to be engineered (i.e., different pore diameters at different depths of the part) vs. being the random pore structure that the current process engenders.

Engineering the pore structure may be important for a tightly controlled process like SiC growing. Briefly, SiC is grown by subliming a polycrystalline SiC powder and depositing this on a substrate that has a seed crystal. An alternate method combines a Si-precursor gas and graphite powder to form the SiC in-situ before it reaches the deposition substrate. The SiC vapor passes through a porous graphite disk. The disk likely serves a couple purposes: 1) it slows the vapor flow from a turbulent to a laminar flow regime before it reaches the substrate; and 2) react with excess Si in the vapor or trap impurities. Therefore, the pore structure in the disk could be crucial to the overall performance of the process.

In another embodiment, 3d printing of pure graphite without binder is contemplated to form three-dimensional objects.

Particularly, graphite particles were partially functionized so function groups (containing oxygen, nitrogen, etc.) were formed on the surface. Then the powder of those functionized graphite particles were printed by Selective Laser Sintering (SLS) process thereby forming 3D graphite objects.

This method can form graphite particles having various sizes and shapes.

Functionization of graphite particles typically occurs on the surface. So the graphite d-spacing (L_{c}) would not change. SLS model (driven by CAD or scan data) can be applied.

During the cross-section laser scanning process, the pulsed laser could heat up the particles to cleave function group from graphite particles (thermal pyrolysis), then chemical bonds (C—C bond) could be formed between adjacent particles.

Product property and application will determine whether a post heat treatment is necessary, although the basis of this idea does not require any further treatment.

Together the SLS technology with functionized graphite particles could prove a novel method for 3D printing graphite

According to another embodiment, SiC, WC, and other carbide materials present machining challenges because of their inherent hardness and durability—characteristics that are otherwise advantageous. Some carbide materials can be prepared by reaction with carbon or graphite. Complex shaped parts of carbon and graphite can be formed using 3D printing. While there are questions as to the densities that can be achieved in the carbon or graphite artifact by this method (i.e., they may be low compared to the 1.77 g/cc of an isomolded graphite)—a relatively low density may not affect the carbide since the conversion process will fill in voids. Reaction-bonded SiC is an example of this process.

Graphite has typically only been used as powder infused in ABS filament (Acrylonitrile Butadiene Styrene) for reducing friction. Initial trials were based on inkjet printing polymeric binder to a mixture of graphite/pitch powder, followed by binder cure (by UV or heat), baking and graphitization. We have proved that complex objects could be printed with this method, but there are drawbacks with this technology, the Polymeric binder will all decompose during baking process, which is a waste and the remaining carbon is not graphitizable.

Therefore a new strategy to print graphite, without using a polymeric binder is proposed. The proposed method uses a melted pitch applied as the liquid adhesive instead of polymeric binder.

This method can have the following attributes: 1) The printing powder including graphite powder, or a mixture of graphite powder with high softening point binder pitch; 2) The adhesive is a melted pitch. The pitch should have following properties: a) Relatively low softening point; b) Very low QI, so it won't clog the printer head/nozzle; and c) High carbon yield. 3) The adhesive, deliver line and print head all will be heated with right temperature control, so a liquid with suitable viscosity will be inkjet printed to the graphite powder. 4) The amount of adhesive printed will be controlled. 5) As the melted binder pitch cools down, it will adhere to graphite powder to form a solid object. 6) The formed piece can be baked, and graphitized if necessary.

TABLE 1

| | Nature of the | | | Coking | Viscosity |
|---|---|---|---|---|---|
| Name | pitch | SP (° C.) | QI (%) | Value (%) | (cps)* |
| Himadri | Coal Tar Pitch | 96.1 | 0.18 | 45.60 | 45 |
| Koppers | Petroleum Pitch | 92.8 | 1 | 44.6 | 35 |

*BROOKFIELD VISCOSITY @ 200° C. - ASTM D5018

Based on the property requirements, two binder pitches (table above) are suggested while in at least one embodiment the Koppers pitch is preferred.

The proposed 3D printing graphite method will have following advantages: 1.) No polymeric binders applied so it reduces cost; 2.) It is based on the matured printing technology; 3.) It's all graphite powder+binder pitch; and 4.) The formed object will have higher density and strength.

According to another embodiment, For both SLS and SLM technologies, the mechanism is the same: to selectively melt powders (usually it is metal, glass or thermoplastics) to form a 3D object. For our purpose, two approaches will be proposed based on the selection of raw materials.

The printing powder is a mixture of graphite powder with high softening point binder pitch. The pitch could be a binder pitch or a mesophase pitch, but it should have following properties: 1) High softening point (less volatile); 2) High carbon yield; 3) Homogeneously mixed with graphite powder; and 4) Pulse Laser beam should be able to melt all pitch powder (with small diameters, compared to graphite powder).

The amount of pitch should be enough to coat and/or wet all graphite powder, at least. For a formed piece, it will need to be baked, and graphitized if necessary.

This method is similar with the one mentioned above, the difference is only pitch powder will be utilized (instead of mixture of graphite powder and pitch powder). The benefit of this method is a very high density object could be achieved, and potentially a higher density and strength graphite could be prepared after baking and graphitization. The risks/disadvantages include: (1) pure pitch powder might be difficult to spread; (2) possible softening the pitch powders outside of the Laser beam path; and (3) Porosity problem during the pitch baking process.

Mesophase pitch is proposed due to its property: high softening point (>300° C.) and high carbon yield.

The power of Laser beam can be carefully controlled, and since the pitch have a much lower melting point compared to metal or glass, greater control will yield improved results.

Post-treatments are necessary to form a graphite object. Significant shrinkage could be a potential problem as well. This embodiment will have following advantages: it's all graphite powder and pitch, which provides the manufacturer greater control of raw materials. The formed object will have high density and strength.

3D printing of insulation is also considered herein. Such a method will reduce lead time and scrap.

3D printed insulation using lignin based precursor materials. Lignin itself should be much less expensive than other carbon or graphite precursor materials. Lignin can be made as both a powder and fiber, which would enable 3D printing to produce insulation parts of varying conductivity, strength, etc. An additional benefit the besides lower cost is customizability of insulation for different applications, in both material properties and geometry. 3D printing would allow control of not only the near-net shape but also the conductivity in ways that are currently not possible with current GRI manufacturing methods.

3D printed insulation with lignin could also allow for lower cost, faster throughput, less waste, and offer the customer more customizability in properties and shapes.

In another embodiment, a method of forming graphite electrodes and/or pins by additively manufactured graphite electrodes and pins using existing or modified additive manufacturing technology, namely:

1) deposit liquid or solid pitch on a bed of coke, and then heat treat;

2) deposit liquid binder onto pitch and/or coke, and then heat treat; and

3) use a laser or other localized heat source to bond powdered mesophase or isotropic pitch, either to itself of powdered coke.

For as long as graphite electrodes and connecting pins have been manufactured for electric arc furnace (EAF) steel melting, the raw materials have been granular coke (carbon) and binder pitch. This was by necessity, as carbon raw materials were only available in these forms. That is, the manufacturing process of graphite electrodes has always been determined by the types of raw materials available. The coke and pitch are mixed together and extruded into an electrode. The anisotropy and particle alignment developed during the extrusion process is important in maintaining low electrical resistance and thermal expansion in the extrusion direction, which is the direction in which current flows down the electrode in steel melting.

However, the rise of additive manufacturing (AM) has opened new possibilities for materials in manufacturing. Previously, there was no other way of making an electrode besides mixing and extruding coke and pitch. However, such a granular (particulate) structure has limitations and also forces a compromise among properties. For example, one must chose a distribution of coke particle sizes to use, and a balance between high strength

A method for forming additively manufactured graphite electrodes and pins using additive manufacturing technology also known as 3D printing comprises:

1) Depositing liquid or solid pitch on a bed of coke.

2) Heat treating the deposited pitch.

3) Depositing liquid binder onto pitch or coke.

4) Heat treating the deposited binder pitch and coke.

5) Localized heating of the pitch bonding the pitch to itself or powdered coke. The pitch being mesophase or isotropic pitch.

For as long as graphite electrodes and connecting pins have been manufactured for electric arc furnace (EAF) steel melting, the raw materials have been granular coke (carbon) and binder pitch. This was by necessity, as carbon raw materials were only available in these forms. That is, the manufacturing process of graphite electrodes has always been determined by the types of raw materials available. The coke and pitch are mixed together and extruded into an electrode. The anisotropy and particle alignment developed during the extrusion process is important in maintaining low electrical resistance and thermal expansion in the extrusion direction, which is the direction in which current flows down the electrode in steel melting.

Previously, there was no other way of making an electrode besides mixing and extruding coke and pitch. However, such a granular (particulate) structure has limitations and also forces a compromise among properties. For example, one must chose a distribution of coke particle sizes to use, and a balance between high strength (small particles) and high thermal shock (larger particles) must be made. Similarly, electricity has to flow across the bond between the coke particles and binder which increases the electrical resistance over that a pure graphite lattice.

With AM, an electrode or connecting pin can be made by printing powdered coke or pitch onto a substrate or bed, and then heat treating. Or, a bed of powdered mesophase pitch or isotropic pitch can be selectively heated with a laser or other localized heat source.

Current state-of-the-art manufacturing of graphite electrodes and connecting pins is very time-consuming and expensive. Lead times are typically at least 4 weeks if not months. In addition, near-net shapes cannot be formed so there are yield losses at various steps in the process. The overall process is very energy intensive, especially in terms of electricity. Furthermore, the final properties are very sensitive to the properties of the coke and pitch raw materials, which means graphite electrodes are very sensitive to supply chain. All these considerations means that manufacturing electrodes is a very complex business with lots of risk.

Additive manufacturing has the potential to revolutionize the way these products are made. The business impact could be substantial in terms of reducing yield losses, streamlining production processes and equipment, reducing energy consumption, reducing vulnerability to raw material swings, reducing CO2 emissions, and improving product uniformity and performance by optimizing and engineering the internal structure.

To make a true 3D composite, currently the process involves weaving fibers in a 2D direction around a z-direction lattice preform. The weaving process is such that only simple shapes like rectangles and cylinders are able to be woven.

We propose 3D composites made by 3D printing. First, current 2D weaving in x-y would be replaced by 2D printing in x-y continuous fiber with resin (for example the Mark One printer by Mark Forged, Boston, Mass.). Holes would be left in a lattice pattern in the 2D layer to be latter filled with pultruded rods in the z-direction. Each 2D x-y layer would be printed, one on top of the other, controlling the fiber orientation in each layer, but making sure the holes in each layer line up. Each 2D layer can be net shape. After the near net shape is made, the holes in each layer form a lattice of channels in the z-direction, which can be filled by pultruded rods. Next, the structure would have to be infiltrated with resin to density the structure into a composite. Finally, the composite would be cured, unless no curing is necessary with the resin. The fibers could be carbon, Kevlar, etc. The resin could be thermoset or thermoplastic.

The goal is to bring down the cost of 3D composites to make them more attractive for industrial applications. The goal is not to match the very high performance of current 3D composites made by weaving, but to have a more scalable process that is lower cost for industrial uses, perhaps the properties would be lower, but still better than and 2D composites on the market.

The cost of this method for forming 3D composites would be lower due to: 1) reduced labor costs, 2) higher throughput, 3) near net shape, and 4) reduced lead time.

Also, it might be easier to make high-temperature composites (like high-temp PMCs) with this idea versus current preform weaving and infiltration.

One challenge with replacing metal parts with carbon fiber reinforced polymers (CFRP) is that CFRP don't have the same thermal conductivity as metals. Conductive additives can be incorporated into CFRP, but often at a high cost and it may make the process more difficult than without using additives.

In one embodiment, 3D thermally conductive composites are made by 3D printing, to overcome limitations with current methods to make thermally conductive composites. First, current 2D weaving in x-y would be replaced by 2D printing in x-y continuous fiber with resin (for example the Mark One printer by Mark Forged, Boston, Mass.). Holes would be left in a lattice pattern in the 2D layer to be latter filled with pultruded rods in the z-direction. Each 2D x-y layer would be printed, one on top of the other, controlling the fiber orientation in each layer, but making sure the holes in each layer line up. Each 2D layer can be net shape.

Furthermore, at a predetermined layer, the printing is paused and a layer of Spreadshield can be incorporated, and then printing is resumed. A single layer of spreadershield can be placed anywhere in the structure, or even multiple layers.

After the near net shape is made, the holes in each layer form a lattice of channels in the z-direction, which can be filled by pultruded rods. Next, the structure would have to be infiltrated with resin to densify the structure into a composite. Finally, the composite would be cured, unless no curing is necessary with the resin. The fibers could be carbon, Kevlar, etc. The resin could be thermoset or thermoplastic.

The goal is to make thermally conductive composites that perform both structural and thermal management functions without any drawback. To compensate for any loss in shear strength or interlaminar strength by incorporating Spreadershield in the composite, pultruded rods in the z-direction add in reinforcement. That way the Spreadershield will conduct heat while the z-direction rods give necessary strength. The 3D printing process also means that thickness should not be an issue, so thick thermally conductive high strength composites can be made.

To increase the usage of composites, they have to perform multiple functions.

Although CFRP have good strength-to-weight, they do not match the thermal conductivity.

By 3D printing thermally conductive composites, offers a polymer matrix composite that has the necessary physical but also thermal characteristics, which should help in areas like robotics.

According to another embodiment a three-dimensional article is formed by building up an article through an extrusion technique wherein a flowable binder is mixed with one or more of the fillers described herein above and the mixture is deposited on a target surface in a layered approach. In accordance with this approach the binder is flowable but then sets or becomes substantially solid shortly after being deposited on the target surface (or on the previous layer of the binder/powder mixture. According to this method, optionally the binder may be set by employing a targeted heat source such as, for example, a laser. In this manner, a three-dimensional article may be formed. The formation of the three dimensional green article may then be followed by heat treatment and/or pitch impregnation as described herein above.

According to another embodiment, a three dimensional article may be formed employing a non-carbonized pitch coated powder. According to this approach (which is similar to a selective laser sintering approach), the article may be produced by tracing a targeted heat source over a dispersed bed of pitch coated powder. In accordance with this approach a separate flowable binder may not be required to form the three dimensional article. The formation of the three dimensional article may then be followed by heat treatment and/or pitch impregnation as described herein above.

A further method disclosed herein for making a three dimensional article includes depositing a plurality of binder coated filler particles to form a monolithic article, wherein said filler includes carbon or graphite. The method also includes heat treating the article in a non-oxidizing environment to at least about 800° C. The word particle used in this application has the same meaning as the word powder.

Another advantage of the above embodiments is that the carbon article which is formed may have a shape other than that of a traditional rectangular or cylindrical billet as known in the carbon and graphite industry. Optionally such shape is a monolithic article and not two (2) or more carbon/graphite articles joined together by a carbonizable and optionally graphitizable cement.

A further advantage is that such shape may be formed without the use of pore formers or other sacrificial material that is consumed during subsequent processing.

Examples of densities of articles which may be made using the above methods include any one of the following: at least about 1.7 g/cc, at least about 1.75 g/cc, at least about 1.8 g/cc, at least about 1.85 g/cc, at least about 1.9 g/cc, at least about 1.95 g/cc, at least about 2.0 g/cc and at least about 2.05 g/cc.

A further advantage of the above methods is that they may be used to produce a carbon or graphite article with minimal extra material. Preferably the mass of the produced article is within twenty (20%) percent of the mass of the desired final article, more preferably within fifteen (15%) percent and even more preferably within ten (10%) percent.

The above description is intended to enable the person skilled in the art to practice the invention. It is not intended to detail all the possible variations and modifications that will become apparent to the skilled worker upon reading the description. It is intended, however, that all such modifications and variations be included within the scope of the invention that is defined by the following claims. Thus, although there have been described particular embodiments of the present invention of a new and useful method for making carbon and/or graphite articles, it is not intended that such references be construed as limitations upon the scope of this invention except as set forth in the following claims.

We claim:

1. A method for making a three dimensional article comprising:
depositing alternating layers of a binder and a filler to form an article, wherein said filler includes at least one of carbon, graphite and combinations thereof; and
heat treating said article in a non-oxidizing environment to at least about 2000° C.

2. The method according to claim 1 wherein said filler further comprises a powder blend including a carbon or graphite powder and a pitch.

3. The method according to claim 2 wherein said binder volatizes at temperatures less than about 200° C.

4. The method according to claim 2 wherein said pitch has a softening point from between about 80° C. and about 300° C.

5. The method according to claim 1 further comprising the step of infusing said article with an impregnating pitch.

6. The method according to claim 1 wherein said powder further comprises a coated powder having a carbon or graphite base powder and a pitch coating.

7. The method according to claim 6 wherein said coated powder has an average diameter from between about 2 to about 200 microns

8. The method according to claim 7 wherein said coating is from between and 1 and about 50 percent by weight of the base powder.

9. The method according to claim 1 wherein said binder comprises coal tar pitch or petroleum pitch.

10. The method according to claim 1 wherein said binder comprises a resin having a coking value greater than about 20 percent.

11. The method according to claim 1 wherein said filler further comprises carbon or graphite powder derived from amorphous carbon, green, calcined or graphitized petroleum, coal tar coke, graphitized powder from synthetic sources, or natural graphite.

12. A method for making a three dimensional article comprising:
forming an article by depositing alternating layers of a binder and a filler, wherein said filler includes a carbon or graphite powder in combination with a milled pitch, said binder volatizing at a temperature greater than a softening point temperature of said milled pitch; and
heat treating said article in a non-oxidizing environment to at least about 800° C.

13. The method according to claim 12 wherein said binder volatizes at temperatures greater than 300° C. and said milled pitch has a softening point less than 300° C.

14. The method according to claim 12 wherein said binder volatizes at temperatures less than about 200° C.

15. The method according to claim 12 wherein said pitch has a softening point temperature from between about 80° C. and about 300° C.

16. The method according to claim 12 wherein further comprising the step of infusing said article with an impregnating pitch.

17. The method according to claim 12 wherein said powder further comprises a coated powder having a carbon or graphite base powder and a pitch coating.

18. The method according to claim 17 wherein said coated powder has an average diameter from between about 2 to about 200 microns

19. The method according to claim 17 wherein said pitch coating is from between and 1 and about 50 percent by weight of the base powder.

20. The method according to claim 12 wherein said binder comprises coal tar pitch or petroleum pitch.

21. The method according to claim 12 wherein said binder comprises a resin having a coking value greater than about 20 percent.

22. A method for making a three dimensional article comprising:
depositing a plurality of binder coated filler particles to form a monolithic article, wherein said filler includes carbon or graphite; and
heat treating said article in a non-oxidizing environment to at least about 800° C.

23. The method of claim 22 wherein a shape of the article prior to the heat treating comprises a shape other than a rectangular billet and a cylindrical billet.
